(19) United States
(12) Patent Application Publication
(10) Pub. No.: US 2025/0314936 A1
(43) Pub. Date: Oct. 9, 2025

(54) PASSIVE DRIVE SCHEME FOR LOCALIZED DIMMING

(71) Applicant: Meta Platforms Technologies, LLC, Menlo Park, CA (US)

(72) Inventors: Gareth John Valentine, Kirkland, WA (US); Rahul Agarwal, Woodinville, WA (US); Kai-Han Chang, Troy, MI (US); Xi Wu, Redmond, WA (US); James Ronald Bonar, Redmond, WA (US)

(21) Appl. No.: 19/086,515

(22) Filed: Mar. 21, 2025

Related U.S. Application Data
(60) Provisional application No. 63/575,437, filed on Apr. 5, 2024.

(51) Int. Cl. G02F 1/137; G02F 1/1343

(52) U.S. Cl. CPC G02F 1/13756; G02F 1/134309; G02F 1/13439

(57) ABSTRACT

A optical element includes a primary electrode array having a plurality of primary electrodes extending in a first direction, a secondary electrode array having a plurality of secondary electrodes extending in a second direction, where at least one secondary electrode overlaps a portion of at least one primary electrode, and a switchable active layer disposed between the primary electrode array and the secondary electrode array, the switchable active layer being configured to modulate light transmission through the optical element in response to an applied voltage.

### CROSS-REFERENCE TO RELATED APPLICATION

This application claims the benefit of priority under 35 U.S.C. § 119 (e) of U.S. Provisional Application No. 63/575,437, filed Apr. 5, 2024, the contents of which are incorporated herein by reference in their entirety.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a schematic view illustrating blanket and pixelated dimming of an optical element according to some embodiments.

FIG. 2 is a schematic illustration of a passive driving scheme having a crossbar architecture according to some embodiments.

FIG. 3 shows a mode of operation of the passive driving scheme architecture of FIG. 2 according to some embodiments.

FIG. 4 illustrates passive matrix addressing of a liquid crystal-based dimming cell according to some embodiments.

FIG. 5 shows an exemplary pixelation paradigm with passive addressing for localized dimming according to certain embodiments.

FIG. 6 shows an exemplary pixelation paradigm with passive addressing for localized dimming according to some embodiments.

FIG. 7 depicts an exemplary pixelation paradigm with passive addressing for localized dimming according to further embodiments.

FIG. 8 is an illustration of exemplary augmented-reality glasses that may be used in connection with embodiments of this disclosure.

FIG. 9 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Virtual reality (VR) and augmented reality (AR) eyewear devices and headsets enable users to experience events, such as interactions with people in a computer-generated simulation of a three-dimensional world or viewing data superimposed on a real-world view. Superimposing information onto a field of view may be achieved through an optical head-mounted display (OHMD) or by using embedded wireless glasses with a transparent heads-up display (HUD) or augmented reality overlay. VR/AR eyewear devices and headsets may be used for a variety of purposes. Governments may use such devices for military training, medical professionals may use such devices to simulate surgery, and engineers may use such devices as design visualization aids.

Virtual reality and augmented reality devices and headsets typically include an optical system having a microdisplay and imaging optics. Display light may be generated and projected to the eyes of a user using a display system where the light is in-coupled into a waveguide, transported therethrough by total internal reflection (TIR), replicated to form an expanded field of view, and out-coupled when reaching the position of a viewer's eye.

The microdisplay may be configured to provide an image to be viewed either directly or indirectly using, for example, a micro OLED display or by illuminating a liquid-crystal based display such as a liquid crystal on silicon (LCoS) microdisplay. Liquid crystal on silicon is a miniaturized reflective or transmissive active-matrix display having a liquid crystal layer disposed over a silicon backplane. During operation, light from a light source is directed at the liquid crystal layer and as the local orientation of the liquid crystals is modulated by a pixel-specific applied voltage, the phase retardation of the incident wavefront can be controlled to generate an image from the reflected or transmitted light. In some instantiations, a liquid crystal on silicon display may be referred to as a spatial light modulator.

LCoS-based projectors typically use three LCoS chips, one each to modulate light in the red, green, and blue channels. An LCOS projector may be configured to deliver the red, green, and blue components of image light simultaneously, which may result in a projected image having rich and well-saturated colors. As will be appreciated, an LCOS display may be configured for wavelength selective switching, structured illumination, optical pulse shaping, in addition to near-eye displays.

Due at least in part to inherent high resolution and high fill factors (minimal inter-pixel spacing), visible pixelation on an LCOS machine may be essentially nonexistent resulting in a high fidelity, continuous image. Moreover, in contrast to micro-mirror based projection systems that can generate high frequencies that accentuate their digital nature, LCoS pixel edges tend to be smoother, which may give them an analog-like response resulting in a more natural image.

In certain applications, the lenses of an AR device may be dimmed to render AR content against bright environmental backgrounds. Dimming techniques may also be effective at preserving display projector power and lifetime. Simply attenuating the entire environmental scene, however, is inadequate in many scenarios. Because the real world remains visible through the dimmed region, the virtual content must be of sufficient brightness to overcome the spatial content of the real world, especially if there are conflicting depth cues within the virtual content.

In view of the foregoing, and in accordance with some embodiments, localized dimming in AR glasses may be achieved by dividing a dimming element into smaller individually-addressable sections or “pixels.” In contrast to global dimming, localized dimming may beneficially impact inclusive rendering, social acceptability, etc. With “local” dimming, selected regions of the display may be dimmed to the exclusion of non-selected regions, which may provide for simultaneous viewing and visibility of both virtual and real world content.

A variation of localized dimming includes the introduction of optical scattering to a real world scene. With optical scattering, real world content behind virtual content may be effectively erased. A switchable scattering material may be used to achieve this effect. However, many such candidate materials, such as polymer-dispersed liquid crystals (PDLCs), require high switching voltages (>10V). Active driving approaches, which require a plurality of individually addressed thin film transistors, will introduce obscurations into the pixel area and hence decrease clear state transparency and also introduce undesired haze and/or scattering.

Dimming technologies can be based on an optical absorption, scattering or reflection effects. These could be implemented by established liquid crystal approaches or by approaches such as reversible metal electrodeposition (RME) which has not been demonstrated in an addressable pixelated scheme.

Notwithstanding recent developments, there remains a need for localized dimming solutions for AR devices and headsets. In accordance with various embodiments, disclosed are passive driving schemes that may be operable at low activation voltages and possess both a low scattering, high optical transmission clear state in the OFF (unpowered) state and an effective dark state that could be absorbing, scattering, or reflecting or combinations thereof in the ON (powered) state. In some configurations, the opposite paradigm could apply, where the ON (powered) state could be the high transmission, low scatter state and the OFF (unpowered) state could be the low transmission, dimming state.

In accordance with particular embodiments, a dimming element includes a layer of functional material disposed between an upper layer and a lower layer of patterned electrodes. The functional material may include any suitable liquid crystal material, electrochromic material, or reversible metal electrodeposition (RME)-based material, for example. The electrodes may be optically transparent and may include, for example, indium tin oxide (ITO) or similar transparent conductive oxides (TCOs) or fin metal meshes, or combinations thereof. The electrode/functional layer/electrode stack may be supported by one or more optically transparent and electrically insulating substrates. The substrate(s) may include glass or plastic, for example.

In certain instantiations, the upper layer electrodes may be configured as an array of continuous rows whereas the lower layer electrodes may be configured as an array of continuous columns (or vice versa). The electrode layers thus form a crossbar architecture that delineates a pixel at each unique row and column “intersection.” Each row of electrodes and each column of electrodes may be electrically connected to a corresponding bus line that could be configured to apply a high current density, low voltage drop along each respective row or column.

Approaches to pixelation may leverage various active layer technologies, including polymer-stabilized liquid crystal (PSLC), liquid crystal physical gel (LCPG), polymer-dispersed liquid crystal (PDLC), polymer-stabilized cholesteric texture (PSCT), polymer network liquid crystal (PNLC), guest-host liquid crystal (GHLC), photochromic (PhCh) layer, electrochromic (EC) layer (i.e., organic or inorganic electrochromic technologies), reversible metal electrodeposition (RME) structure, and ferroelectric nematic liquid crystal (FNLC). Such technologies may be current driven or field driven. In accordance with particular embodiments, exemplary active layer technologies may be characterized by a threshold (rather than continuous) switching voltage.

Also disclosed is a voltage driving scheme for individually addressing one or more pixels with minimal cross-talk to neighboring pixels. In an example passive driving configuration, assuming a threshold voltage of X Volts for a given dimming element and a technology-dependent overdrive voltage of Y Volts, a selected pixel may be turned on by applying a positive bias of (X+Y)/2 Volts to the electrode row corresponding to the targeted pixel, and a negative bias of (X+Y)/2 Volts to the electrode column corresponding to the targeted pixel. Neighboring bus bars may be biased to 0 V. Accordingly, the pixel of interest will see an applied voltage of X+Y Volts and will be turned ON. In contrast, neighboring pixels will see an applied voltage of only (X+Y)/2 and for Y<X will remain OFF. As will be appreciated, the foregoing can be extended to multiple pixel addressing. Passive driving may obviate design and manufacturing complexities of active driving paradigms, particular in the context of thin film transistor (TFT)-based active driving. In other configurations, the drive signal to the neighboring bus bars may be triple state and therefore can be set to a floating high impedance state when not addressed.

As used herein, a material or element that is “transparent” or “optically transparent” may, for a given thickness, have a transmissivity within the visible light spectrum of at least approximately 80%, e.g., approximately 80, 90, 95, 97, 98, 99, or 99.5%, including ranges between any of the foregoing values, and less than approximately 5% bulk haze, e.g., approximately 0.1, 0.2, 0.5, 1, 2, or 5% bulk haze, including ranges between any of the foregoing values. Transparent materials will typically exhibit very low optical absorption and minimal optical scattering.

As used herein, the terms “haze” and “clarity” may refer to an optical phenomenon associated with the transmission of light through a material, and may be attributed, for example, to the refraction of light within the material, e.g., due to secondary phases or porosity and/or the reflection of light from one or more surfaces of the material. As will be appreciated, haze may be associated with an amount of light that is subject to wide angle scattering (i.e., at an angle greater than 2.5° from normal) and a corresponding loss of transmissive contrast, whereas clarity may relate to an amount of light that is subject to narrow angle scattering (i.e., at an angle less than 2.5° from normal) and an attendant loss of optical sharpness or “see through quality.”

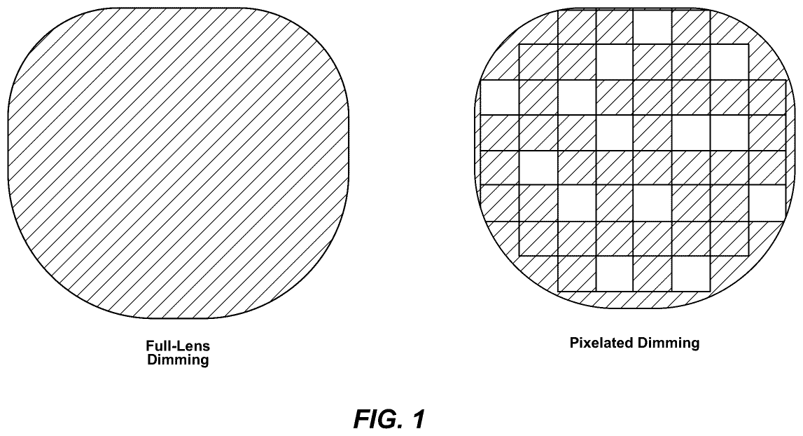

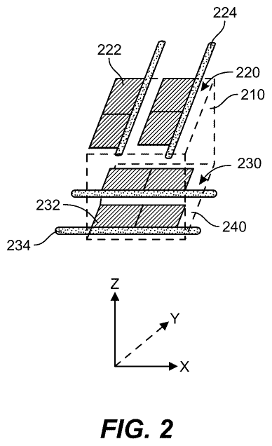

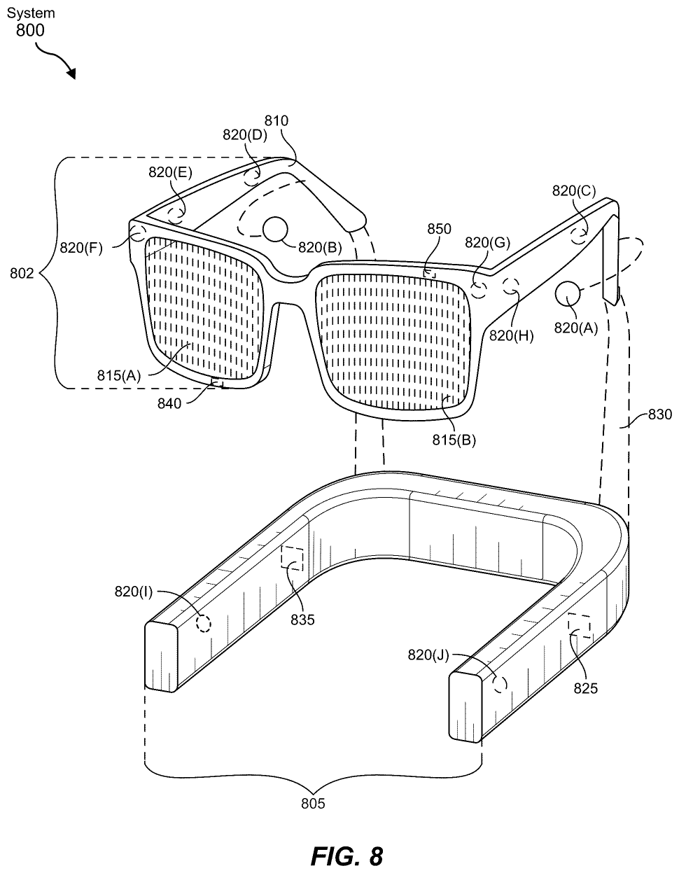

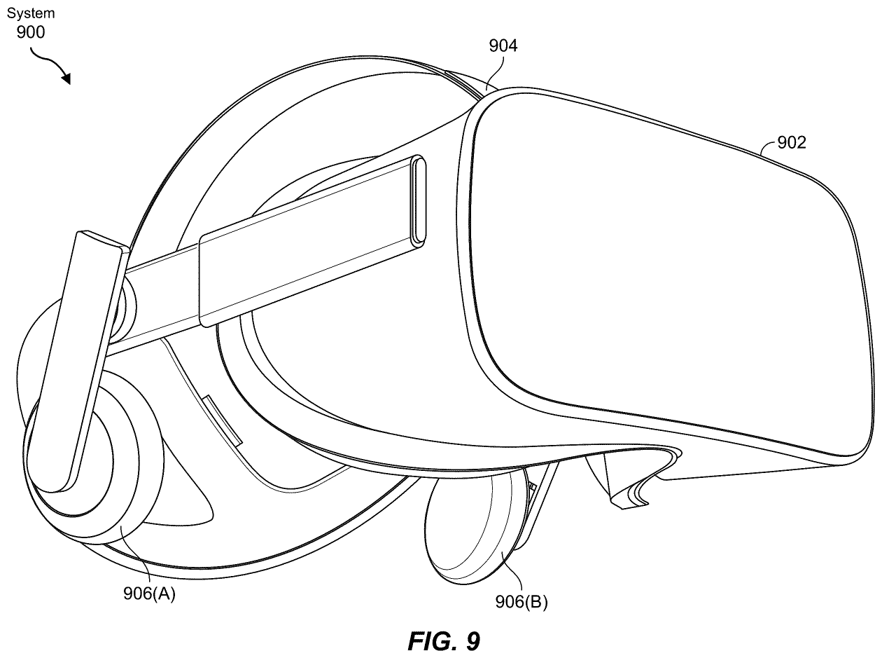

The following will provide, with reference to FIGS. 1-9, detailed descriptions of cell architectures for spatially localized dimming using an electrochromic or reversible metal electrodeposition (RME)-based element. The discussion associated with FIG. 1 includes a description of global and pixelated dimming. The discussion associated with FIGS. 2-7 includes a description of passive pixelization approaches for locally addressing and controlling the light attenuation properties of a functional dimming element. The discussion associated with FIGS. 8 and 9 relates to exemplary virtual reality and augmented reality devices that may include one or more passive driving schemes as disclosed herein.

Referring to FIG. 1, shown is a schematic view comparing full lens dimming and pixelated or localized dimming according to some embodiments. An example passive driving scheme to affect localized dimming is shown in the perspective view of FIG. 2. The structure includes a liquid crystal or other functional layer 210 sandwiched between opposing electrode arrays 220, 230. A first (top) electrode array 220 includes a plurality of individual transparent electrodes 222 arranged along isolated columns (e.g., along a y-direction) whereas a second (bottom) electrode array 230 includes a plurality of individual transparent electrodes 232 arranged along isolated rows (e.g., along an x-direction) and in opposition to the first electrode configuration. A dielectric layer 240 may be used to isolate adjacent columns or rows of electrodes. Bus lines 224, 234 are respectively configured to electrically power each individual electrode column or row. The arrangement of mutually orthogonal electrodes in the first and second (top and bottom) arrays forms a crossbar architecture where individual pixels may be defined by a unique overlapping address between the electrode arrays.

In some configurations, especially for technologies such as reversible metal electrodeposition (RME), one set of electrodes may constitute the bus bars only and does not include a transparent electrode, where the bus bars include a metal, e.g., zinc, silver, copper, nickel, etc., operative as a counter-electrode.

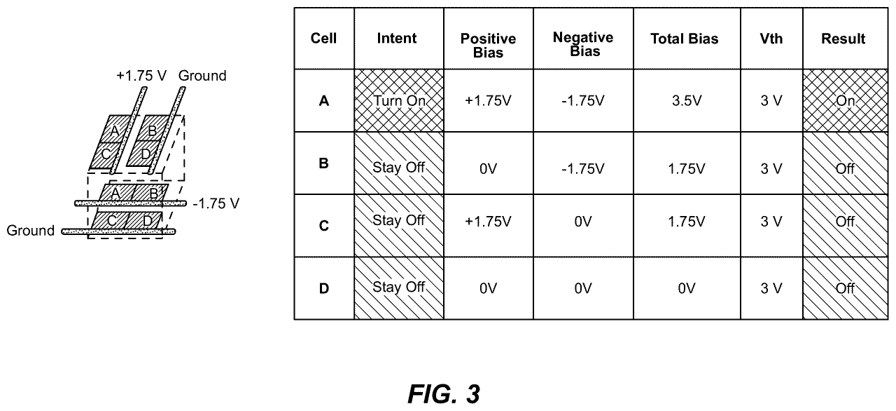

The operation of an example dimming cell is shown in FIG. 3, which depicts schematically the application of a bias to one column and one row of the first and second electrode arrays, respectively. In the illustrated example, a functional material within the active layer corresponding to the “A” cell may induce dimming in response to the applied voltage.

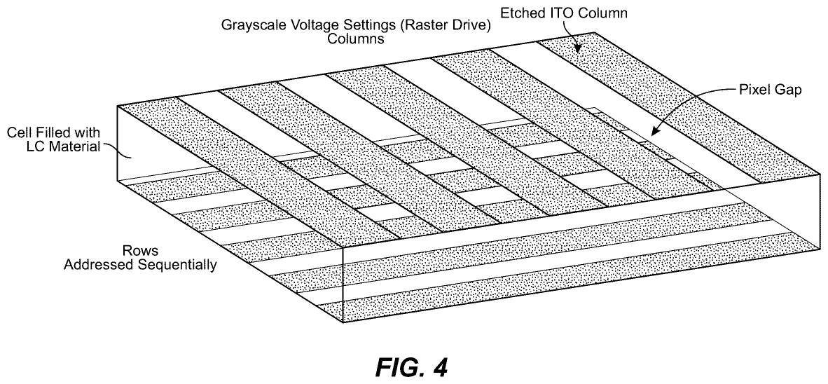

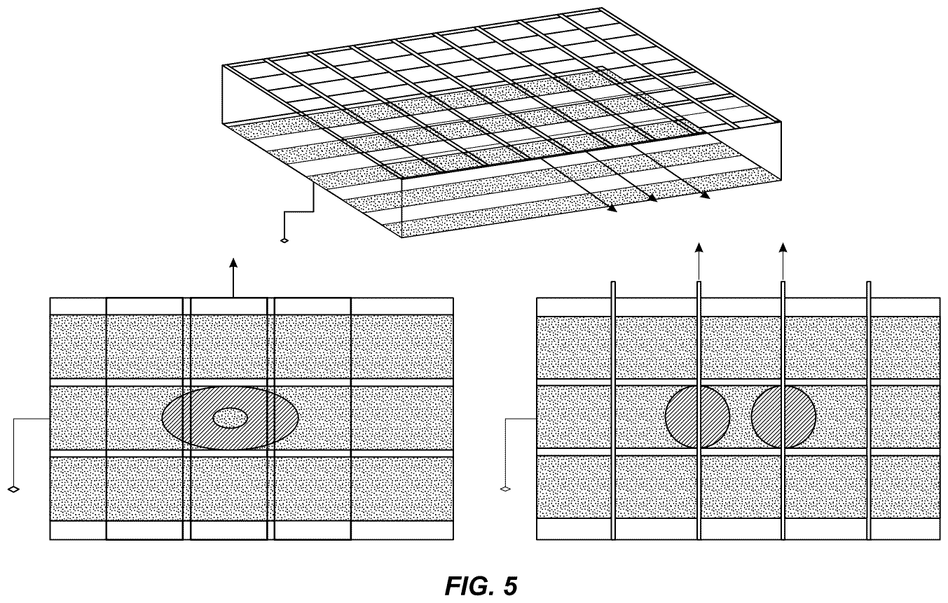

Further passive matrix addressing paradigms are illustrated schematically in FIGS. 4-8. As shown in FIGS. 4 and 5, for example, a passively addressed dimming cell may include a liquid crystal layer disposed between mutually-orthogonal electrode arrays (i.e., rows and columns) where individual pixels are defined at overlapping regions of the electrodes. The electrode arrays may be formed using a patterning and etching process. In some embodiments, rows of electrodes may be addressed sequentially while selected columns of electrodes may be positively or negatively biased to darken or lighten corresponding pixels.

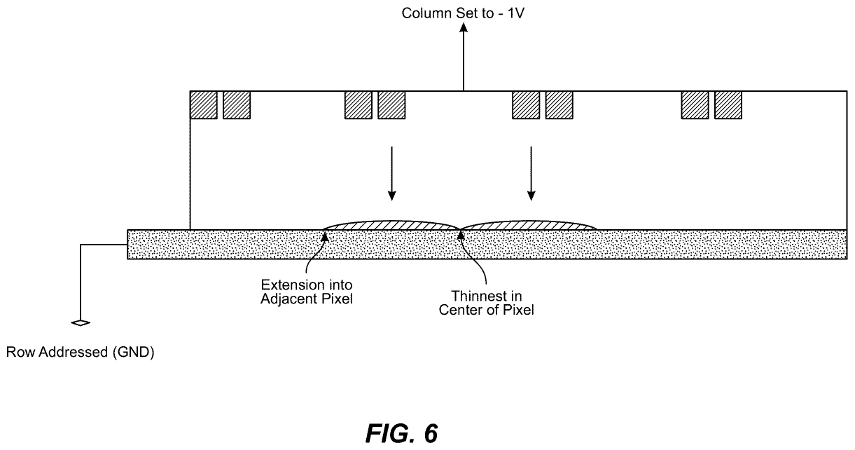

Referring to FIG. 6, shown is a cross-sectional view of a row of electrodes, and the darkening of a single pixel. In certain implementations, an electrode row to be addressed may be grounded with other rows floating. For pixel darkening, selected columns may be biased positively relative to ground. For pixel lightening, selected columns may be biased negatively relative to ground.

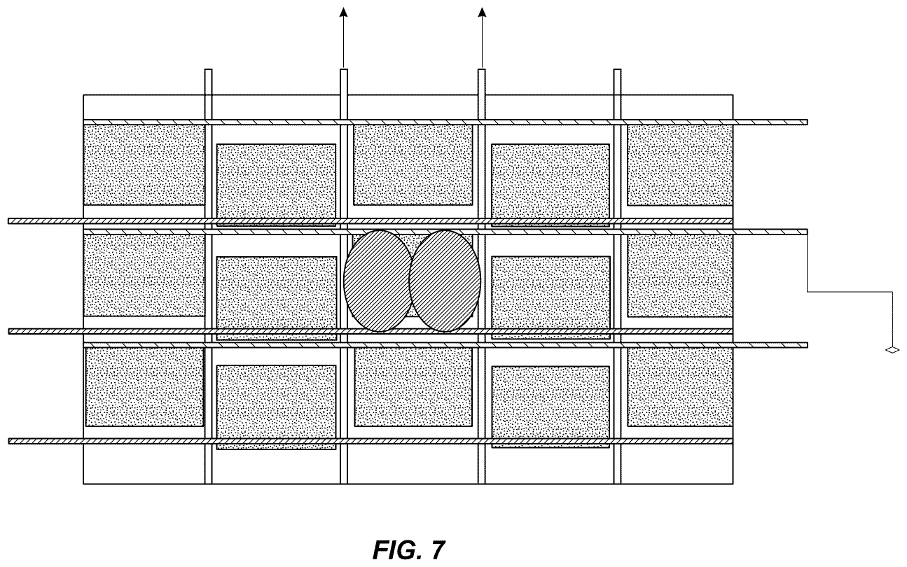

Referring to FIG. 7, in some embodiments, pixel cross-talk may be decreased, and pixel fidelity improved by interlacing rows of electrodes to increase the spacing between adjacent addressed pixels.

### EXAMPLE EMBODIMENTS

Example 1: An optical element includes a primary electrode array having a plurality of primary electrodes extending in a first direction, a secondary electrode array having a plurality of secondary electrodes extending in a second direction, where at least one secondary electrode overlaps a portion of at least one primary electrode, and a switchable active layer disposed between the primary electrode array and the secondary electrode array, where the switchable active layer is configured to modulate light transmission through the optical element in response to an applied voltage.

Example 2: The optical element of Example 1, where the primary electrodes and the secondary electrodes are substantially optically transparent.

Example 3: The optical element of any of Examples 1 and 2, where an angle between the first direction and the second direction is 30 degrees to 90 degrees.

Example 4: The optical element of any of Examples 1-3, where the plurality of primary electrodes form a plurality of rows, the plurality of secondary electrodes form a plurality of columns, and individual electrode rows and columns are electrically isolated from each other.

Example 5: The optical element of any of Examples 1-4, where the switchable active layer includes an assembly selected from a polymer-stabilized liquid crystal (PSLC), a liquid crystal physical gel (LCPG), a polymer-dispersed liquid crystal (PDLC), a polymer-stabilized cholesteric texture (PSCT), a polymer network liquid crystal (PNLC), a guest-host liquid crystal (GHLC), an electrochromic (EC) layer, a reversible metal electrodeposition (RME) structure, and a ferroelectric nematic liquid crystal (FNLC).

Example 6: The optical element of any of Examples 1-5, where the switchable active layer includes a material characterized by a threshold switching voltage.

Example 7: The optical element of any of Examples 1-6, where the switchable active layer includes a material having a degree of optical bi-stability.

Example 8: The optical element of any of Examples 1-7, where the switchable active layer is configured to provide a high optical transmission clear state in an unbiased state and a low transmission dimming state in a biased state.

Example 9: The optical element of any of Examples 1-8, where the switchable active layer includes a switchable scattering material configured to introduce optical scattering to a real-world scene.

Example 10: The optical element of any of Examples 1-9, where the switchable active layer is disposed between optically transparent and electrically insulating substrates.

Example 11: The optical element of any of Examples 1-10, where the switchable active layer is configured to modulate light transmission through one or more of optical absorption, scattering, and reflection effects.

Example 12: An optical element includes a primary electrode array having a plurality of primary electrodes extending in a first direction, a secondary electrode array having a plurality of secondary electrodes extending in a second direction, where at least one secondary electrode overlaps a portion of at least one primary electrode, individual primary and secondary electrodes are electrically isolated from each other, and an angle between the first direction and the second direction is approximately 90 degrees, and a switchable active layer disposed between the primary electrode array and the secondary electrode array, where the switchable active layer is configured to modulate light transmission through the optical element in response to an applied voltage.

Example 13: The optical element of Example 12, where the primary electrodes and the secondary electrodes are substantially optically transparent.

Example 14: The optical element of any of Examples 12 and 13, where the switchable active layer includes an assembly selected from a polymer-stabilized liquid crystal (PSLC), a liquid crystal physical gel (LCPG), a polymer-dispersed liquid crystal (PDLC), a polymer-stabilized cholesteric texture (PSCT), a polymer network liquid crystal (PNLC), a guest-host liquid crystal (GHLC), an electrochromic (EC) layer, a reversible metal electrodeposition (RME) structure, and a ferroelectric nematic liquid crystal (FNLC).

Example 15: The optical element of any of Examples 12-14, where the switchable active layer includes a material characterized by a threshold switching voltage.

Example 16: The optical element of any of Examples 12-15, where the switchable active layer includes a material having a degree of optical bi-stability.

Example 17: The optical element of any of Examples 12-16, where the switchable active layer is configured to provide a high optical transmission clear state in an unbiased state and a low transmission dimming state in a biased state.

Example 18: An optical element includes a plurality of primary electrodes extending in a first direction, a plurality of secondary electrodes extending in a second direction orthogonal to the first direction, wherein at least one secondary electrode overlaps a portion of at least one primary electrode, and a switchable active layer disposed between the plurality of primary electrodes and the plurality of secondary electrodes, where the switchable active layer is configured to modulate light transmission through the optical element in response to an applied voltage.

Example 19: The optical element of Example 18, where the primary electrodes and the secondary electrodes are substantially optically transparent.

Example 20: The optical element of any of Examples 18 and 19, where the plurality of primary electrodes form a plurality of rows, the plurality of secondary electrodes form a plurality of columns, and individual electrode rows and columns are electrically isolated from each other.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (e.g., augmented-reality system 800 in FIG. 8) or that visually immerses a user in an artificial reality (e.g., virtual-reality system 900 in FIG. 9). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 8, augmented-reality system 800 may include an eyewear device 802 with a frame 810 configured to hold a left display device 815(A) and a right display device 815(B) in front of a user's eyes. Display devices 815(A) and 815(B) may act together or independently to present an image or series of images to a user. While augmented-reality system 800 includes two displays, embodiments of this disclosure may be implemented in augmented-reality systems with a single NED or more than two NEDs.

In some embodiments, augmented-reality system 800 may include one or more sensors, such as sensor 840. Sensor 840 may generate measurement signals in response to motion of augmented-reality system 800 and may be located on substantially any portion of frame 810. Sensor 840 may represent a position sensor, an inertial measurement unit (IMU), a depth camera assembly, a structured light emitter and/or detector, or any combination thereof. In some embodiments, augmented-reality system 800 may or may not include sensor 840 or may include more than one sensor. In embodiments in which sensor 840 includes an IMU, the IMU may generate calibration data based on measurement signals from sensor 840. Examples of sensor 840 may include, without limitation, accelerometers, gyroscopes, magnetometers, other suitable types of sensors that detect motion, sensors used for error correction of the IMU, or some combination thereof.

Augmented-reality system 800 may also include a microphone array with a plurality of acoustic transducers 820(A)-820(J), referred to collectively as acoustic transducers 820. Acoustic transducers 820 may be transducers that detect air pressure variations induced by sound waves. Each acoustic transducer 820 may be configured to detect sound and convert the detected sound into an electronic format (e.g., an analog or digital format). The microphone array in FIG. 8 may include, for example, ten acoustic transducers: 820(A) and 820(B), which may be designed to be placed inside a corresponding ear of the user, acoustic transducers 820(C), 820(D), 820(E), 820(F), 820(G), and 820(H), which may be positioned at various locations on frame 810, and/or acoustic transducers 820(1) and 820(J), which may be positioned on a corresponding neckband 805.

In some embodiments, one or more of acoustic transducers 820(A)-(F) may be used as output transducers (e.g., speakers). For example, acoustic transducers 820(A) and/or 820(B) may be earbuds or any other suitable type of headphone or speaker.

The configuration of acoustic transducers 820 of the microphone array may vary. While augmented-reality system 800 is shown in FIG. 8 as having ten acoustic transducers 820, the number of acoustic transducers 820 may be greater or less than ten. In some embodiments, using higher numbers of acoustic transducers 820 may increase the amount of audio information collected and/or the sensitivity and accuracy of the audio information. In contrast, using a lower number of acoustic transducers 820 may decrease the computing power required by an associated controller 850 to process the collected audio information. In addition, the position of each acoustic transducer 820 of the microphone array may vary. For example, the position of an acoustic transducer 820 may include a defined position on the user, a defined coordinate on frame 810, an orientation associated with each acoustic transducer 820, or some combination thereof.

Acoustic transducers 820(A) and 820(B) may be positioned on different parts of the user's ear, such as behind the pinna, behind the tragus, and/or within the auricle or fossa. Or, there may be additional acoustic transducers 820 on or surrounding the ear in addition to acoustic transducers 820 inside the ear canal. Having an acoustic transducer 820 positioned next to an ear canal of a user may enable the microphone array to collect information on how sounds arrive at the ear canal. By positioning at least two of acoustic transducers 820 on either side of a user's head (e.g., as binaural microphones), augmented-reality device 800 may simulate binaural hearing and capture a 3D stereo sound field around about a user's head. In some embodiments, acoustic transducers 820(A) and 820(B) may be connected to augmented-reality system 800 via a wired connection 830, and in other embodiments acoustic transducers 820(A) and 820(B) may be connected to augmented reality system 800 via a wireless connection (e.g., a Bluetooth connection). In still other embodiments, acoustic transducers 820(A) and 820(B) may not be used at all in conjunction with augmented-reality system 800.

Acoustic transducers 820 on frame 810 may be positioned along the length of the temples, across the bridge, above or below display devices 815(A) and 815(B), or some combination thereof. Acoustic transducers 820 may be oriented such that the microphone array is able to detect sounds in a wide range of directions surrounding the user wearing the augmented-reality system 800. In some embodiments, an optimization process may be performed during manufacturing of augmented reality system 800 to determine relative positioning of each acoustic transducer 820 in the microphone array.

In some examples, augmented-reality system 800 may include or be connected to an external device (e.g., a paired device), such as neckband 805. Neckband 805 generally represents any type or form of paired device. Thus, the following discussion of neckband 805 may also apply to various other paired devices, such as charging cases, smart watches, smart phones, wrist bands, other wearable devices, hand-held controllers, tablet computers, laptop computers, other external compute devices, etc.

As shown, neckband 805 may be coupled to eyewear device 802 via one or more connectors. The connectors may be wired or wireless and may include electrical and/or non-electrical (e.g., structural) components. In some cases, eyewear device 802 and neckband 805 may operate independently without any wired or wireless connection between them. While FIG. 8 illustrates the components of eyewear device 802 and neckband 805 in example locations on eyewear device 802 and neckband 805, the components may be located elsewhere and/or distributed differently on eyewear device 802 and/or neckband 805. In some embodiments, the components of eyewear device 802 and neckband 805 may be located on one or more additional peripheral devices paired with eyewear device 802, neckband 805, or some combination thereof.

Pairing external devices, such as neckband 805, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 800 may be provided by a paired device or shared between a paired device and an eyewear device, thus reducing the weight, heat profile, and form factor of the eyewear device overall while still retaining desired functionality. For example, neckband 805 may allow components that would otherwise be included on an eyewear device to be included in neckband 805 since users may tolerate a heavier weight load on their shoulders than they would tolerate on their heads. Neckband 805 may also have a larger surface area over which to diffuse and disperse heat to the ambient environment. Thus, neckband 805 may allow for greater battery and computation capacity than might otherwise have been possible on a stand-alone eyewear device. Since weight carried in neckband 805 may be less invasive to a user than weight carried in eyewear device 802, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 805 may be communicatively coupled with eyewear device 802 and/or to other devices. These other devices may provide certain functions (e.g., tracking, localizing, depth mapping, processing, storage, etc.) to augmented-reality system 800. In the embodiment of FIG. 8, neckband 805 may include two acoustic transducers (e.g., 820(I) and 820(J)) that are part of the microphone array (or potentially form their own microphone subarray). Neckband 805 may also include a controller 825 and a power source 835.

Acoustic transducers 820(I) and 820(J) of neckband 805 may be configured to detect sound and convert the detected sound into an electronic format (analog or digital). In the embodiment of FIG. 8, acoustic transducers 820(I) and 820(J) may be positioned on neckband 805, thereby increasing the distance between the neckband acoustic transducers 820(I) and 820(J) and other acoustic transducers 820 positioned on eyewear device 802. In some cases, increasing the distance between acoustic transducers 820 of the microphone array may improve the accuracy of beamforming performed via the microphone array. For example, if a sound is detected by acoustic transducers 820(C) and 820(D) and the distance between acoustic transducers 820(C) and 820(D) is greater than, e.g., the distance between acoustic transducers 820(D) and 820(E), the determined source location of the detected sound may be more accurate than if the sound had been detected by acoustic transducers 820(D) and 820(E).

Controller 825 of neckband 805 may process information generated by the sensors on neckband 805 and/or augmented-reality system 800. For example, controller 825 may process information from the microphone array that describes sounds detected by the microphone array. For each detected sound, controller 825 may perform a direction-of-arrival (DOA) estimation to estimate a direction from which the detected sound arrived at the microphone array. As the microphone array detects sounds, controller 825 may populate an audio data set with the information. In embodiments in which augmented-reality system 800 includes an inertial measurement unit, controller 825 may compute all inertial and spatial calculations from the IMU located on eyewear device 802. A connector may convey information between augmented-reality system 800 and neckband 805 and between augmented-reality system 800 and controller 825. The information may be in the form of optical data, electrical data, wireless data, or any other transmittable data form. Moving the processing of information generated by augmented-reality system 800 to neckband 805 may reduce weight and heat in eyewear device 802, making it more comfortable to the user.

Power source 835 in neckband 805 may provide power to eyewear device 802 and/or to neckband 805. Power source 835 may include, without limitation, lithium ion batteries, lithium-polymer batteries, primary lithium batteries, alkaline batteries, or any other form of power storage. In some cases, power source 835 may be a wired power source. Including power source 835 on neckband 805 instead of on eyewear device 802 may help better distribute the weight and heat generated by power source 835.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 900 in FIG. 9, that mostly or completely covers a user's field of view. Virtual-reality system 900 may include a front rigid body 902 and a band 904 shaped to fit around a user's head. Virtual-reality system 900 may also include output audio transducers 906(A) and 906(B). Furthermore, while not shown in FIG. 9, front rigid body 902 may include one or more electronic elements, including one or more electronic displays, one or more inertial measurement units (IMUs), one or more tracking emitters or detectors, and/or any other suitable device or system for creating an artificial reality experience.

Artificial-reality systems may include a variety of types of visual feedback mechanisms. For example, display devices in augmented-reality system 800 and/or virtual-reality system 900 may include one or more liquid crystal displays (LCDs), light emitting diode (LED) displays, organic LED (OLED) displays, digital light project (DLP) micro-displays, liquid crystal on silicon (LCoS) micro-displays, and/or any other suitable type of display screen. Artificial-reality systems may include a single display screen for both eyes or may provide a display screen for each eye, which may allow for additional flexibility for varifocal adjustments or for correcting a user's refractive error. Some artificial-reality systems may also include optical subsystems having one or more lenses (e.g., conventional concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some artificial-reality systems may include one or more projection systems. For example, display devices in augmented-reality system 800 and/or virtual-reality system 900 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world.

The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

Artificial-reality systems may also include various types of computer vision components and subsystems. For example, augmented-reality system 800 and/or virtual-reality system 900 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

Artificial-reality systems may also include one or more input and/or output audio transducers. In the examples shown in FIG. 9, output audio transducers 906(A) and 906(B) may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

While not shown in FIG. 8, artificial-reality systems may include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

It will be understood that when an element such as a layer or a region is referred to as being formed on, deposited on, or disposed “on” or “over” another element, it may be located directly on at least a portion of the other element, or one or more intervening elements may also be present. In contrast, when an element is referred to as being “directly on” or “directly over” another element, it may be located on at least a portion of the other element, with no intervening elements present.

As used herein, the term “approximately” in reference to a particular numeric value or range of values may, in certain embodiments, mean and include the stated value as well as all values within 10% of the stated value. Thus, by way of example, reference to the numeric value “50” as “approximately 50” may, in certain embodiments, include values equal to 50±5, i.e., values within the range 45 to 55.

As used herein, the term “substantially” in reference to a given parameter, property, or condition may mean and include to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least approximately 90% met, at least approximately 95% met, or even at least approximately 99% met.

While various features, elements or steps of particular embodiments may be disclosed using the transitional phrase “comprising,” it is to be understood that alternative embodiments, including those that may be described using the transitional phrases “consisting of” or “consisting essentially of,” are implied. Thus, for example, implied alternative embodiments to a lens that comprises or includes polycarbonate include embodiments where a lens consists essentially of polycarbonate and embodiments where a lens consists of polycarbonate.

What is claimed is:

1. An optical element comprising:
a primary electrode array comprising a plurality of primary electrodes extending in a first direction;
a secondary electrode array comprising a plurality of secondary electrodes extending in a second direction, wherein at least one secondary electrode overlaps a portion of at least one primary electrode; and
a switchable active layer disposed between the primary electrode array and the secondary electrode array, wherein the switchable active layer is configured to modulate light transmission through the optical element in response to an applied voltage.

2. The optical element of claim 1, wherein the primary electrodes and the secondary electrodes are substantially optically transparent.

3. The optical element of claim 1, wherein an angle between the first direction and the second direction is 30 degrees to 90 degrees.

4. The optical element of claim 1, wherein the plurality of primary electrodes form a plurality of rows, the plurality of secondary electrodes form a plurality of columns, and individual electrode rows and columns are electrically isolated from each other.

5. The optical element of claim 1, wherein the switchable active layer comprises an assembly selected from the group consisting of a polymer-stabilized liquid crystal (PSLC), a liquid crystal physical gel (LCPG), a polymer-dispersed liquid crystal (PDLC), a polymer-stabilized cholesteric texture (PSCT), a polymer network liquid crystal (PNLC), a guest-host liquid crystal (GHLC), an electrochromic (EC) layer, a reversible metal electrodeposition (RME) structure, and a ferroelectric nematic liquid crystal (FNLC).

6. The optical element of claim 1, wherein the switchable active layer comprises a material characterized by a threshold switching voltage.

7. The optical element of claim 1, wherein the switchable active layer comprises a material having a degree of optical bi-stability.

8. The optical element of claim 1, wherein the switchable active layer is configured to provide a high optical transmission clear state in an unbiased state and a low transmission dimming state in a biased state.

9. The optical element of claim 1, wherein the switchable active layer includes a switchable scattering material configured to introduce optical scattering to a real-world scene.

10. The optical element of claim 1, wherein the switchable active layer is disposed between optically transparent and electrically insulating substrates.

11. The optical element of claim 1, wherein the switchable active layer is configured to modulate light transmission through one or more of optical absorption, scattering, and reflection effects.

12. An optical element comprising:
a primary electrode array comprising a plurality of primary electrodes extending in a first direction;
a secondary electrode array comprising a plurality of secondary electrodes extending in a second direction, where at least one secondary electrode overlaps a portion of at least one primary electrode, individual primary and secondary electrodes are electrically isolated from each other, and an angle between the first direction and the second direction is approximately 90 degrees; and
a switchable active layer disposed between the primary electrode array and the secondary electrode array, where the switchable active layer is configured to modulate light transmission through the optical element in response to an applied voltage.

13. The optical element of claim 12, wherein the primary electrodes and the secondary electrodes are substantially optically transparent.

14. The optical element of claim 12, wherein the switchable active layer comprises an assembly selected from the group consisting of a polymer-stabilized liquid crystal (PSLC), a liquid crystal physical gel (LCPG), a polymer-dispersed liquid crystal (PDLC), a polymer-stabilized cholesteric texture (PSCT), a polymer network liquid crystal (PNLC), a guest-host liquid crystal (GHLC), an electrochromic (EC) layer, a reversible metal electrodeposition (RME) structure, and a ferroelectric nematic liquid crystal (FNLC).

15. The optical element of claim 12, wherein the switchable active layer comprises a material characterized by a threshold switching voltage.

16. The optical element of claim 12, wherein the switchable active layer comprises a material having a degree of optical bi-stability.

17. The optical element of claim 12, wherein the switchable active layer is configured to provide a high optical transmission clear state in an unbiased state and a low transmission dimming state in a biased state.

18. An optical element comprising:
a plurality of primary electrodes extending in a first direction;
a plurality of secondary electrodes extending in a second direction orthogonal to the first direction, wherein at least one secondary electrode overlaps a portion of at least one primary electrode; and
a switchable active layer disposed between the plurality of primary electrodes and the plurality of secondary electrodes, wherein the switchable active layer is configured to modulate light transmission through the optical element in response to an applied voltage.

19. The optical element of claim 18, wherein the primary electrodes and the secondary electrodes are substantially optically transparent.

20. The optical element of claim 18, wherein the plurality of primary electrodes form a plurality of rows, the plurality of secondary electrodes form a plurality of columns, and individual electrode rows and columns are electrically isolated from each other.
